(19) United States
(12) Patent Application Publication
(10) Pub. No.: US 2011/0153142 A1
(43) Pub. Date: Jun. 23, 2011

(54) Vehicle Installed Cement Mixer Control

(75) Inventors: Patrick M. Delaney, Fort Wayne, IN (US); Colin J. Casey, Fort Wayne, IN (US)

(73) Assignee: International Truck Intellectual Property Company, LLC., Warrenville, IL (US)

(21) Appl. No.: 12/642,012

(22) Filed: Dec. 18, 2009

(51) Int. Cl. G06F 7/00; G06F 17/00

(52) U.S. Cl. 701/29; 700/265

(57) ABSTRACT

For a cement mixer installed on a vehicle, a vehicle controller area network is modified to develop from engine speed, hydraulic power take-off system pressure and programmed data on power take-off pump capacity estimates of rotational speed and barrel rotational count. The network can also maintain a constant barrel rotational speed during transportation.

### BACKGROUND OF THE INVENTION

### 1. Technical Field

The invention relates to the control of hydraulic power take-off systems for motor vehicles and more particularly to application of such control to hydraulic power take systems for a vehicle mounted cement mixer drum.

### 2. Description of the Problem

Contemporary trucks are often equipped for power takeoff operation (PTO). PTO is used with auxiliary systems such as hoists, lifts, and pumps that are directly or indirectly powered by the vehicle's engine. Indirectly powered systems, such as hydraulic systems, are among the most popular. Power for an auxiliary hydraulic system is converted from engine output by an engine driven hydraulic pump. The hydraulic pump draws working fluid from a tank and supplies fluid to a hydraulic valve manifold which can divert the working fluid to a cylinder or impeller used to move a target load.

Original vehicle manufacturers have long supplied general purpose hydraulic pumps with their vehicles which are suitable for supporting hydraulic power take off operation. In the past the provision of controls and hydraulic lines was generally left to after market specialists. Retrofitted controls have sometimes left something to desired in terms of integration of the new wiring and hydraulic lines required.

Vehicle system integrated hydraulic power take-off systems utilizing modular components and requiring minimum modification of the vehicle have been recently developed as described in U.S. Patent Publication 2005/0206113, which is assigned to the assignee of the present invention and incorporated herein by reference. The Patent Publication teaches a system which includes a hydraulic fluid tank, a hydraulic valve manifold, an engine driven pump, and a switch and instrument panel. The system is suitable for a variety of applications. The control aspects of these systems, which are integrated with a vehicle controller area network (CAN), are of particular interest. These systems include a hydraulic valve controller and an auxiliary gauge and switch controller for connection to the vehicle controller area network and which provide integration of control over hydraulic system operation with vehicle operation. Control protocols are adapted from standard SAE J-1939 bus signals. Other vehicle controllers are monitored for standard signals for implementing interlocks as required and signals relating to engine controller control over the engine are readily invoked.

Operators of cement mixers need to know the mixer barrel rotation count and the rotational velocity of the mixer barrel to ensure mixing the cement properly. For a cement mixer mounted on a vehicle the rotational velocity of the mixer barrel must be monitored and kept at a constant rate while a charge is transported. Current mixer systems monitor mixer barrel speed using a speed sensor system that is mounted to the barrel. The sensor system requires an additional sensor and a tone ring to implement which raises reliability issues and which add to cost. Rotational velocity information is displayed to the driver/operator who must make the adjustments required to keep the operation within defined limits.

### SUMMARY OF THE INVENTION

According to the invention there is provided a vehicle system integrating control of over a power take-off driven, vehicle mounted cement mixer with a vehicle controller network to monitor vehicle operating variables which are used in turn to determine cement mixer barrel rotational speed and barrel rotation count. There is no need to use direct sensing of barrel operation. The system also provides for maintaining barrel rotation at a constant speed during transportation.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a side elevation of a truck with a cement mixer installed for hydraulic power takeoff operation.

FIG. 2 is a schematic illustration of the hydraulic and electronic control systems used for a hydraulic power take-off vehicle mounted cement mixer.

FIG. 3 is a front elevation of an application control panel for a cement mixer barrel control system.

FIG. 4 is a data flow diagram.

### DETAILED DESCRIPTION OF THE INVENTION

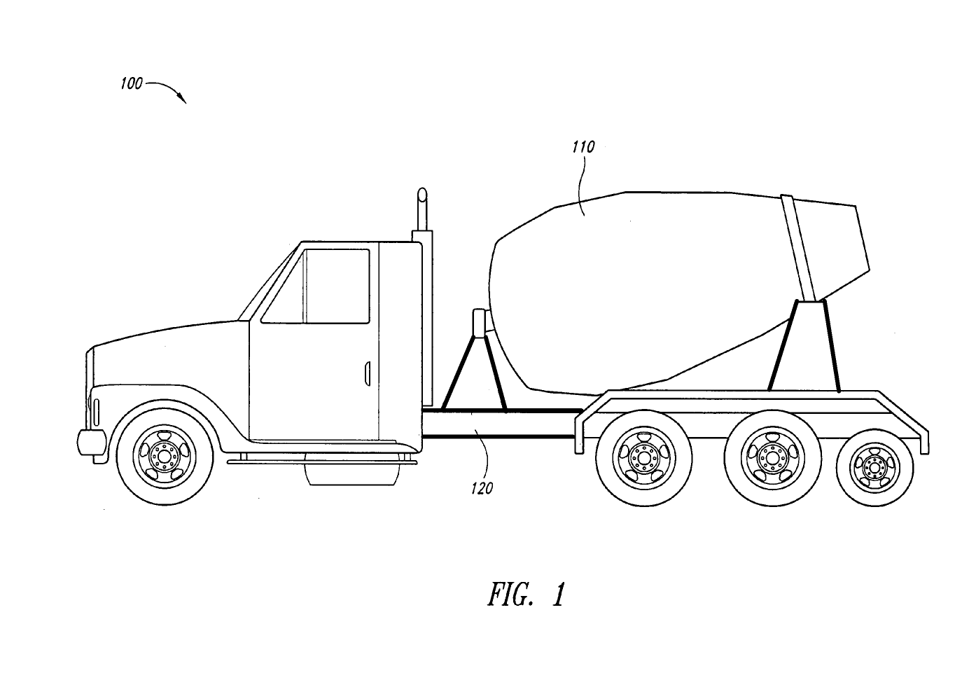

Referring now to the figures and particularly to FIG. 1, a truck 100 is depicted having a chassis 120 on which a cement mixer barrel 110 is mounted for rotation. In accordance with the teachings of the invention an integrated hydraulic power take-off system tracks mixer barrel 110 rotation velocity and the number of rotations made by the barrel.

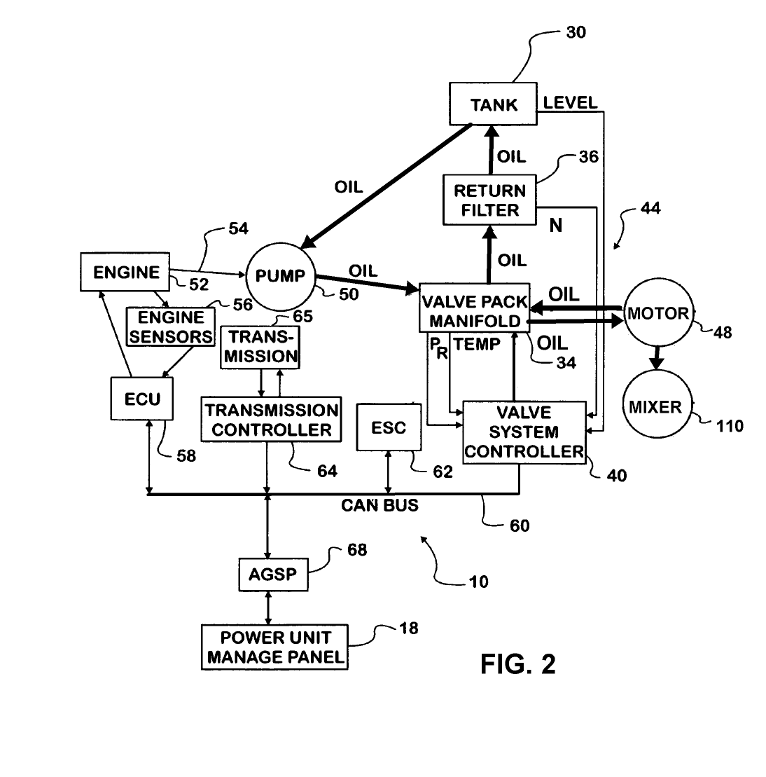

FIG. 2 illustrates a vehicle hydraulic PTO system 44 and a vehicle electrical control system 10 which are used to monitor and control the cement mixer barrel 110. Hydraulic PTO system 44 rotates the cement mixer barrel 110 using pressurized oil/hydraulic fluid supplied by a pump 50. Hydraulic fluid is selectively delivered to a hydraulic motor 48 which turns barrel 110 through a valve pack manifold 34. Valve pack manifold 34 allows pressurized hydraulic fluid to be delivered to hydraulic motor 48 as part of a circulating hydraulic fluid circuit, hydraulic PTO system 44, and provides for directional control as well as control over barrel 110 as well as control over the barrel's rotational speed. Hydraulic fluid circulates through the hydraulic circuit or PTO system 44 from valve pack manifold 34 to return filter 36, then to a tank or reservoir 30 from which fluid is drawn and pressurized by a pump 50 for return to the valve pack manifold. Valve positions in valve pack manifold 34 are controlled by a valve system controller 40. The valve system controller/hydraulic electronic control unit 40 includes (or controls) solenoids which physically move the valves in the pack manifold 34. Valve system controller 40 monitors a number of system operating variables. Controller 40 monitors the hydraulic fluid level (LEVEL) in reservoir 30, the system oil pressure (P_{R}) and the temperature (TEMP) from manifold 34. Return filter 36 condition is indicated by the pressure drop (N) across the filter which is reported by a sensor to valve system controller 40. The valve system controller 40 is connected to CAN bus 60 for data communication with other vehicle controllers including data relating to the operating system variables.

Pump 50 is powered by vehicle engine 52 through a mechanical linkage 54 to the engine crankshaft (not shown). PTO operation may be enhanced by utilizing an engine control unit (ECU) 58 which monitors engine operating variables using engine sensors 56. While engine sensors 56 are illustrated as being direct intermediaries between ECU 58 and engine 52, related instruments, such as a tachometer, may in fact be connected to the transmission 65, with the resulting signal provided directly to the ECU or indirectly to the ECU through a transmission controller 64 over controller area network (CAN) bus 60. Integration of the components is preferably provided by a program resident on and executed by an electrical system controller (ESC) 62 and communicating with other controllers over CAN bus 60. CAN bus 60 preferably conforms to the SAE J1939 standard. Communication between the valve system controller 40 and an auxiliary gauge and switch package (AGSP) 68 to an operator interface (i.e. panel 18) is provided by CAN bus 60. CAN bus 60 typically provides a physical backbone comprising a twisted pair (either shielded or unshielded) cable operating as a data link or serial data bus. ESC 62 manages the assorted vocational controllers (e.g. valve system controller 40 and ECU 58) connected to bus 60 as nodes. Based on data received from the valve pack manifold 34 and passed to the ESC 62, coupled with knowledge about the capacity of pump 50 (pump 50 typically is an engine driven pump providing 12 gallons per minute flow at 3000 psi at a given engine speed), the ESC 62 can estimate the rotational velocity and rotation count of barrel 110.

The SAE J1939 protocol defines a number of messages which may be readily adapted to serve the requirements of a hydraulic PTO system. The auxiliary gauge and switch pack controller 68 allows hydraulic system information to be easily and conveniently displayed to the operator. Since present on the CAN bus 60, the data can be read by ESC 62, which uses the data in conjunction with engine speed data form the ECU 58 or transmission controller 64 to calculate rotational speed of and rotation count for barrel 110.

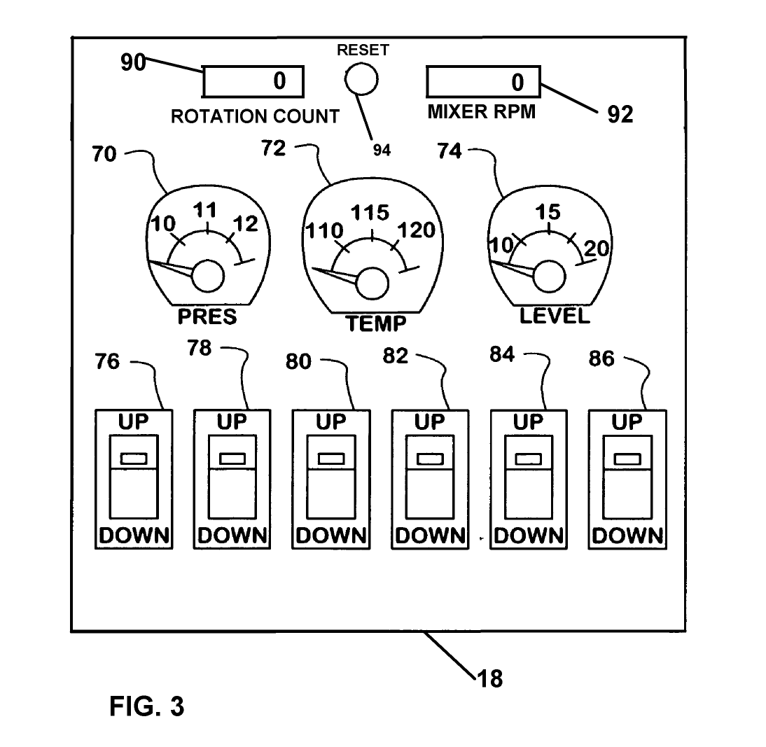

Referring now to FIG. 3, a control and instrument panel 18 suitable for implementing control over a hydraulic power takeoff operation system and associated vehicle auxiliary system is illustrated. While panel 18 is typically mounted on a vehicle, it may be installed on a radio controlled remote unit. Three gauges are provided including a system pressure gauge 70, an hydraulic fluid temperature gauge 72 and an hydraulic fluid level gauge 74. The gauges may incorporate warning lights to draw operator attention to out of norm operating conditions. Six three way rocker switches 76, 78, 80, 82, 84 and 86 are also provided, which may be labeled as required for the particular application of the system. In general, the association of the switches with a particular function is implemented in software and labeling of the switches as desired will typically follow. For a cement mixer switch 76 may be an enable switch. Switch 78 may be used for clockwise rotation and switch 80 for counterclockwise rotation. The remaining switches may be reserved for chute positioning. An optional reset button 94 is shown and two counters 90, 92 provided indicating current barrel 110 rotation velocity and the rotation count are provided. Each switch may incorporate a light, the operation of which may be programmed to indicate system availability or state of the switch.

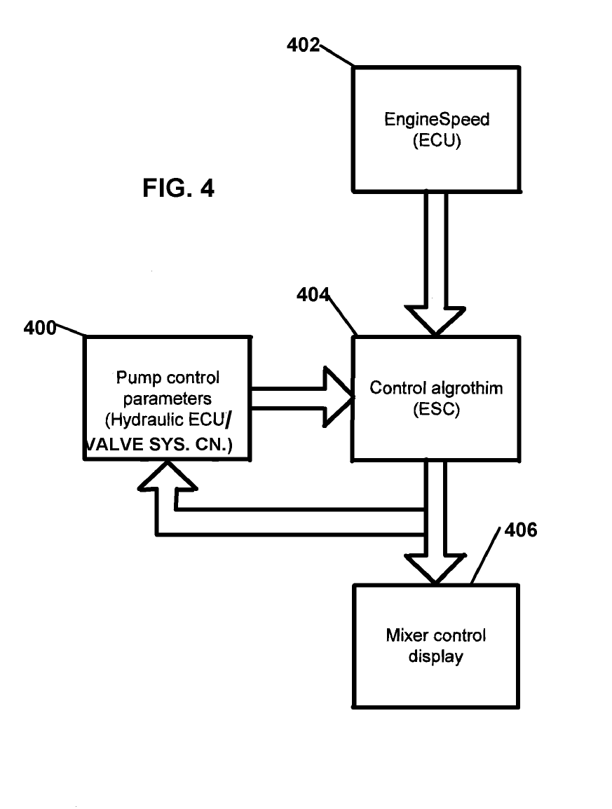

FIG. 4 illustrates the flow of data used to implement the invention. The control algorithm 404 determines barrel speed based on engine speed 402, hydraulic system operating variables (pump speed) and system parameters 400, such as pump displacement, which is known. Pump speed may be a linear function in engine speed. Because hydraulic fluid is essentially incompressible barrel speed is locked to flow (displacement X speed) produced by the pump. Barrel speed over time produces a count of barrel rotations. Barrel speed and rotation count are passed as data 406 for display.

The invention provides improved reliability and reduced cost by elimination of conventional physical sensors used for monitoring barrel operation, and by estimating the required results by indirect means from existing data.

While the invention is shown in only one of its forms, it is not thus limited but is susceptible to various changes and modifications without departing from the spirit and scope of the invention.

What is claimed is:

1. A motor vehicle comprising:
an engine with a sensor reporting engine speed;
a hydraulic power take off pump of known displacement driven by the engine;
a hydraulic circuit coupled to the hydraulic power take off pump for the circulation of hydraulic fluid;
a sensor for reporting hydraulic circuit pressure;
a hydraulic motor;
a cement mixer barrel mounted for rotation on the vehicle and coupled to the hydraulic motor for operation;
a hydraulic system manifold controlling coupling of the hydraulic motor into the hydraulic circuit for operating the hydraulic motor;
a controller area network including a system bus and an electrical system controller, the sensors being coupled for reporting hydraulic system pressure and engine speed over the system bus for use by the electrical system controller; and
the electrical system controller being programmed to use engine speed, pump displacement and hydraulic system pressure for determining barrel rotational speed and number of rotations from a selected starting point.

2. A motor vehicle in accordance with claim 1, further comprising:
the electrical system controller being further programmed for directing the directing the hydraulic system manifold to set a constant speed of rotation for the cement mixer barrel during transportation.

3. A cement mixer system comprising:
a prime mover;
a sensor for reporting prime mover speed;
a hydraulic power take off pump of known displacement driven by the prime mover;
a hydraulic circuit including the hydraulic power take off pump;
a hydraulic motor;
a cement mixer barrel mounted for rotation and coupled to the hydraulic motor for operation;
a hydraulic system manifold controlling coupling of the hydraulic motor into the hydraulic circuit for operating the hydraulic motor;
a programmable controller coupled to receive the prime mover speed and programmed with the displacement for the hydraulic power take-off pump; and
the electrical system controller being programmed to use prime mover speed and displacement to determine cement mixer barrel rotational speed and number of rotations of the cement mixer barrel from a selected starting point for preparing cement for pouring.

4. A cement mixer system in accord with claim 3, the programmed controller providing for maintaining a constant barrel rotational speed as required until pouring.
